(19) United States
(12) Patent Application Publication
(10) Pub. No.: US 2022/0248905 A1
(43) Pub. Date: Aug. 11, 2022

(54) Apparatus and Method For A Mobile Fryer System

(71) Applicant: Remarkable Foods, Inc., Clark, NJ (US)

(72) Inventors: William Bartz, Kansas City, MO (US); Andrew William O'Sullivan, Brooklyn, NY (US)

(21) Appl. No.: 17/174,346

(22) Filed: Feb. 11, 2021

(51) Int. Cl. A47J 37/12; A23L 5/10; A47J 36/32; B60K 35/00; B60P 3/025

(52) U.S. Cl. CPC A47J 37/1285; A47J 37/1266; A47J 37/1257; A23L 5/11; B60K 2370/16; B60K 35/00; B60P 3/0257; A47J 2203/00; A23V 2002/00; A47J 36/321

(57) ABSTRACT

A fryer system includes a fryer and an oil storage assembly. The oil storage assembly includes a feed pipe coupled at a first end to a fry pot of the fryer and coupled at a second end to a pump assembly. The pump assembly includes a pump and a valve. The oil storage system further includes a storage pipe coupled at a first end to the pump assembly and coupled at a second end to a storage tank. The fryer system can perform an oil fill operation whereby the pump drives cooking oil from the storage tank to the fry pot and an oil drain operation whereby the pump drives cooking oil from the fry pot to the storage tank. A controller controls the oil fill and oil drain operations and transmits communications to a remote command center. The controller can also transmit communications to a driver display device.

### TECHNICAL FIELD

Embodiments of the technology relate generally to a fryer system for food preparation in a vehicle.

### BACKGROUND

Conventional fryers cook food by submerging the food in hot cooking oil for a period of time. The cooking oil is heated in a fry pot by a heat source that is typically powered by natural gas or electricity. The food is placed in a wire basket, the wire basket is submerged in the hot cooking oil until the food is cooked, and then the wire basket containing the cooked food is raised up out of the hot cooking oil. Commercial fryers can include a filtration system for filtering food crumbs and other sediment from the cooking oil so that the cooking oil can be used for a longer period of time. However, eventually, the cooking oil must be replaced. The Frymaster OCF30 Fryer is one example of a commercial fryer with a filtration system.

While portable commercial fryers exist, they are not designed to be transported and they present unique challenges with respect to removing and replacing cooking oil from the fryer. These challenges are particularly acute when the commercial fryer is mounted in a vehicle. For example, it may be necessary to drain the cooking oil from the fry pot before the vehicle begins moving in order to prevent the cooking oil from splashing out of the fry pot due to the motion of the vehicle. However, draining and refilling cooking oil from the fry pot can be a time-consuming process that wastes energy as heat dissipates from the cooking oil when it is not in the fry pot. Additionally, draining and refilling cooking oil can be a cumbersome and hazardous process in which the cooking oil may spill or burn the operator.

Therefore, in light of the challenges presented with the operation of a fryer when it is mounted in a vehicle, an improved fryer that addresses one or more of these challenges would be beneficial.

### SUMMARY

The present disclosure is generally directed to an improved fryer system suitable for use in a vehicle. In one example embodiment, the present disclosure is directed to a fryer system comprising a fryer and an oil storage assembly. The fryer comprises a fry pot for containing cooking oil during the cooking process. The oil storage assembly comprises a feed pipe coupled at a first end to the fry pot via a fryer fitting and coupled at a second end to a pump assembly, wherein the pump assembly comprises a pump and a valve. Additionally, a first end of a storage pipe is coupled to the pump assembly and a second end of the storage pipe is coupled to a storage tank via a storage tank fitting. The storage tank fitting comprises a storage valve.

In the foregoing example embodiment, the oil storage assembly can comprise a controller that controls the operation of the pump assembly. Additionally, in the foregoing example embodiment, the oil storage assembly can comprise a controller that transmits to a remote command center, via an antenna, an oil fill signal when the pump drives cooking oil from the storage tank to the fry pot and an oil drain signal when the pump drives cooking oil from the fry pot to the storage tank. Furthermore, in the foregoing example embodiment, the oil storage assembly can comprise a controller that transmits to a driver display device, via an antenna, a ready message when the pump drives cooking oil from the fry pot to the storage tank.

In another example embodiment, the present disclosure is directed to a method for operating a fryer system wherein the method comprises an oil fill operation, a cooking operation, and an oil drain operation. The oil fill operation comprises supplying power, by a controller, to a pump assembly comprising a pump and a valve. The pump drives cooking oil from a storage tank, through a storage pipe, through a feed pipe, and into a fry pot of fryer. After the pump drives the cooking oil into the fry pot, the controller transmits an oil fill completion signal to a remote commend center. Additionally, after the pump drives the cooking oil into the fry pot, food can be cooked during the cooking operation. After the cooking operation, the oil drain operation comprises supplying power, by the controller, to the pump and the valve of the pump assembly. The pump drives the cooking oil from the fry pot, through the feed pipe, through the storage pipe, and into the storage tank. Lastly, the controller transmits an oil drain completion signal to the remote command center.

In the foregoing example method, the controller can withhold power from the fryer when the controller supplies power to the pump assembly during the oil fill operation. Similarly, the controller can withhold power from the fryer when the controller supplies power to the pump assembly during the oil drain operation. Furthermore, in the foregoing example embodiment, the controller can withhold power from the pump assembly after the oil fill operation is complete and can supply power to the fryer during the cooking operation. Lastly, in the foregoing example embodiment, the oil storage assembly can comprise a controller that transmits to a driver display device, via an antenna, a ready message after the pump drives cooking oil from the fry pot to the storage tank during the oil drain operation.

The foregoing embodiments are non-limiting examples and other aspects and embodiments will be described herein. The foregoing summary is provided to introduce various concepts in a simplified form that are further described below in the detailed description. This summary is not intended to identify required or essential features of the claimed subject matter nor is the summary intended to limit the scope of the claimed subject matter.

### BRIEF DESCRIPTION OF THE DRAWINGS

The accompanying drawings illustrate only example embodiments of a fryer system and therefore are not to be considered limiting of the scope of this disclosure. The principles illustrated in the example embodiments of the drawings can be applied to alternate methods and apparatus for a fryer system. Additionally, the elements and features shown in the drawings are not necessarily to scale, emphasis instead being placed upon clearly illustrating the principles of the example embodiments. Certain dimensions or positions may be exaggerated to help visually convey such principles. In the drawings, the same reference numerals used in different embodiments designate like or corresponding, but not necessarily identical, elements.

FIG. 1 is a perspective view of a fryer system in accordance with the example embodiments of the disclosure.

FIG. 2 is another perspective view of the fryer system of FIG. 1 in accordance with the example embodiments of the disclosure.

FIG. 3 is a side perspective view of an oil storage assembly in accordance with the example embodiments of the disclosure.

FIG. 4 is a top perspective view of the oil storage assembly of FIG. 3 in accordance with the example embodiments of the disclosure.

FIG. 5 is a front perspective view of the oil storage assembly of FIG. 3 in accordance with the example embodiments of the disclosure.

FIG. 6 is a flow chart of an example method of operating a fryer system in accordance with the example embodiments of the disclosure.

FIG. 7 is another flow chart of an example method of operating a fryer system in accordance with the example embodiments of the disclosure.

### DETAILED DESCRIPTION OF EXAMPLE EMBODIMENTS

The example embodiments discussed herein are directed to apparatus and methods for a fryer system. The example embodiments described herein can provide an advantageous fryer system that can be used in vehicles in which food is prepared. Specifically, the example embodiments described herein provide a fryer system in which cooking oil can be stored in an oil storage assembly so that it does not spill while the vehicle is in motion. Furthermore, the oil storage assembly can quickly pump cooking oil into the fryer so that a cooking operation can begin promptly after the vehicle has been stopped. After the cooking operation is complete, the cooking oil can be quickly pumped back into the oil storage assembly so that the cooking oil is safely stored before the vehicle begins moving. The oil storage assembly allows an operator to quickly and efficiently transition between a driving status, where the vehicle is in motion and the cooking oil is stored securely, and a cooking status, where the vehicle is stationary and cooking oil has been pumped into the fryer for cooking.

The oil storage assembly conserves energy in that heated cooking oil can be transferred between the fryer and the oil storage assembly while minimizing heat loss from the cooking oil. At the completion of a cooking operation, a pump assembly can immediately transfer the heated cooking oil from the fryer to the oil storage assembly after which the vehicle can proceed to a new location. Upon arriving at the new location, the pump assembly can promptly pump the cooking oil from the oil storage assembly back into the fryer. The cooking oil can retain much of its heat while stored in the oil storage assembly, thereby minimizing the amount of heat needed to reheat the cooking oil for cooking at the new location.

As will be described further in the following examples, the methods and apparatus described herein improve upon prior art fryer systems. The techniques described herein provide a fryer system that simplifies operation and improves energy efficiency. The techniques described herein eliminate undesirable components and conditions when compared to prior art approaches.

In the following paragraphs, particular embodiments will be described in further detail by way of example with reference to the drawings. In the description, well-known components, methods, and/or processing techniques are omitted or briefly described. Furthermore, reference to various feature(s) of the embodiments is not to suggest that all embodiments must include the referenced feature(s).

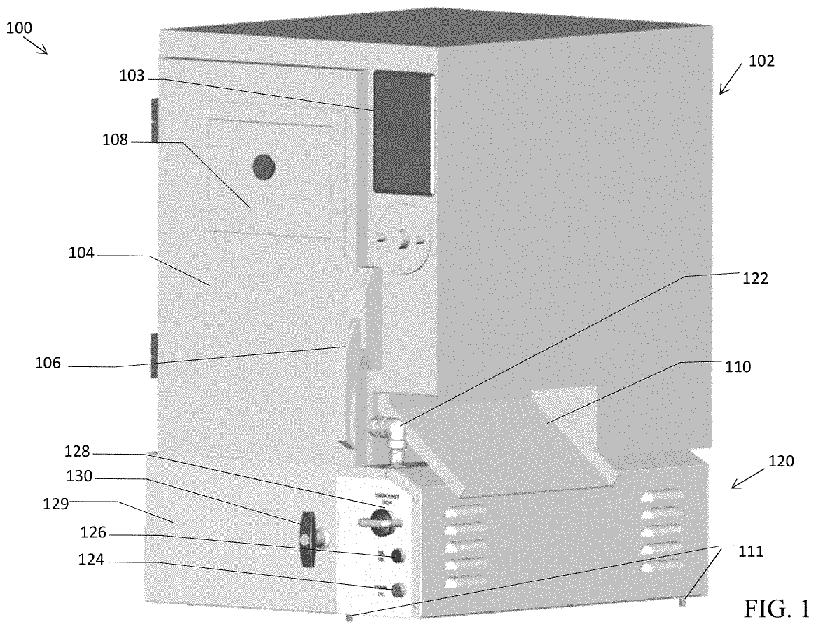

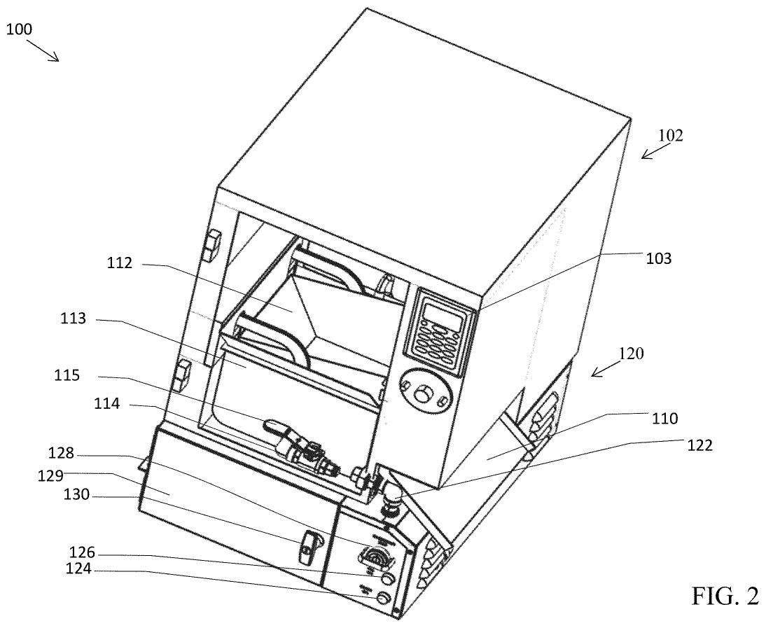

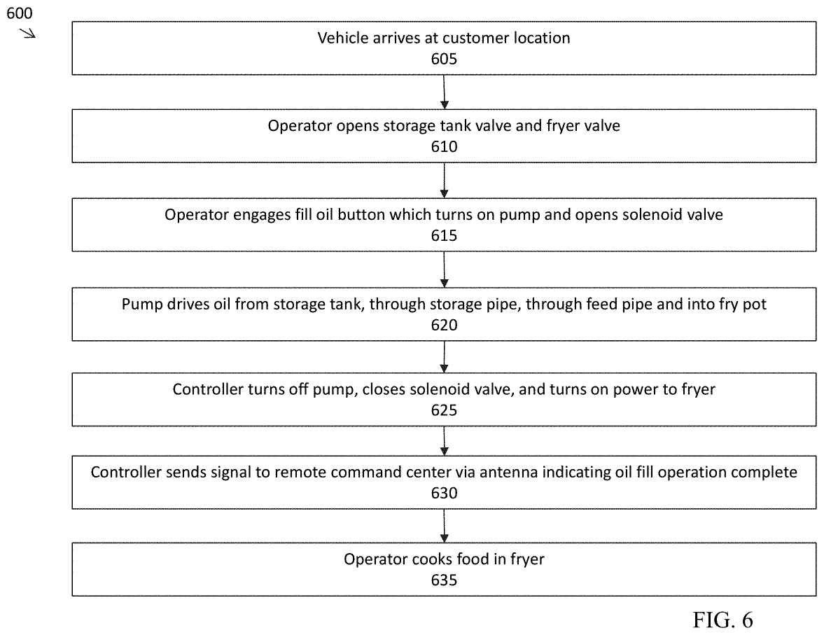

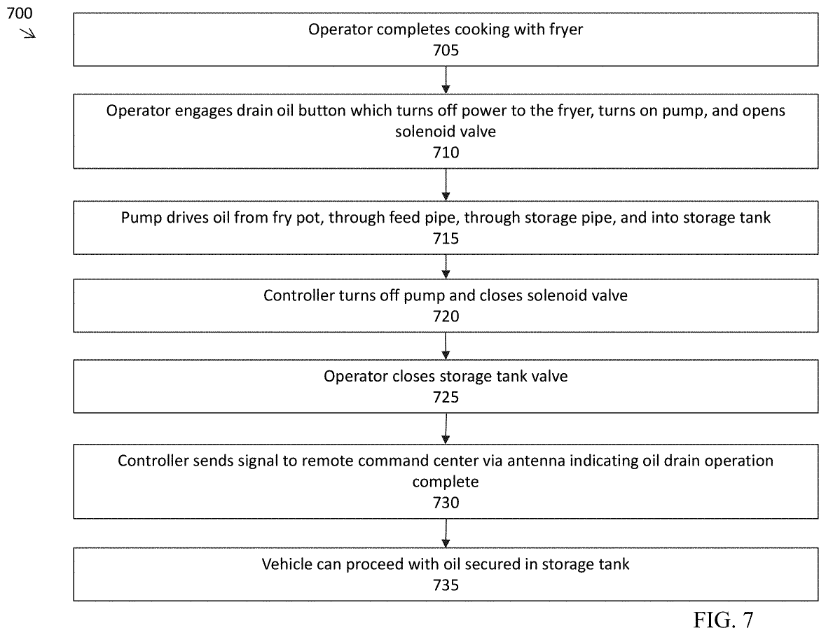

FIGS. 1-5 illustrate aspects of an example fryer system 100. FIGS. 6 and 7 illustrate example methods for operating a fryer system. Referring now to FIG. 1, a top perspective view of an exterior of a fryer system 100 is illustrated in accordance with the example embodiments of the present disclosure. FIG. 2 illustrates the fryer system 100 with certain exterior components removed providing a view of the interior of the fryer system 100. Fryer system 100 includes a fryer 102 mounted on top of an oil storage assembly 120. The arrangement of the fryer 102 on top of the oil storage assembly 120 provides a compact design for the interior of a vehicle. However in other embodiments, the oil storage assembly can be located in other positions with respect to the fryer 102.

The interior of the fryer 102 includes a fry pot 113 that stores cooking oil. A fry basket 112 is shown positioned in the fry pot 113. The fry basket 112 can hold food for lowering into the cooking oil in the fry pot 113. Located below the fry pot 113 is a heating element (not shown) which heats the cooking oil in the fry pot 113 thereby cooking the food located in the fry basket 112. In the example fry system 100, the heating element is an electric heating element. A control panel 103 can control the heating element and the temperature of the cooking oil. When cooking is complete, the fry basket 112 can be rotated so that the cooked food slides down a chute 110 and onto a tray.

The fryer 102 includes a fryer access door 104 that can be opened and closed using fryer handle 106. The fryer access door 104 provides the operator with access to the fry basket 112. The fryer access door 104 also includes an optional observation panel 108 that permits an observer to monitor the food cooking inside the fryer without opening the larger fryer access door 104. It should be understood that the foregoing components of the fryer 102 are only examples and alternate embodiments may omit certain components or have different components.

Attached to the fry pot 113 is a fryer fitting 114 through which cooking oil can flow into and out of the fry pot 113. The fryer fitting 114 includes an optional fryer valve 115 that can be used to control the flow of cooking oil into and out of the fry pot 113. In the example shown in FIG. 2, the fryer valve 115 is a manual valve that can be opened and closed by rotating the handle of the valve. The fryer fitting 114 attaches to a feed pipe 122 that serves as the conduit for cooking oil between the fryer 102 and the oil storage assembly 120. Although shown separated in FIG. 2, the fryer fitting 114 and the feed pipe 122 can be connected with a threaded union as is well known. Because heated cooking oil will be flowing through the feed pipe 122, a gasket of the appropriate material that can withstand high temperatures can be positioned around the feed pipe 122 where it passes through the side wall of the fryer 102.

Also shown in FIGS. 1 and 2 are external features of the oil storage assembly 120. The external features include mounts for securing the fryer system 100 within a vehicle, such as the mounts 111 shown along the bottom of the fryer system 100 in FIG. 1. The mounts 111 can secure the fryer system 100 to a counter or other secure surface within the vehicle to ensure that the fryer system 100 does not shift when the vehicle is in motion. The external features of the fryer system 100 further include an oil fill button 126 that initiates an oil fill operation whereby cooking oil is pumped from the oil storage assembly 120 into the fryer 102. There is also an oil drain button 124 that initiates an oil drain operation whereby cooking oil is pumped from the fryer 102 into the oil storage assembly 120. An emergency stop button 128 stops all pumping operations. The front side of the oil storage assembly 120 also comprises an oil storage access door 129 which is opened and closed with handle 130 providing access to the interior of the oil storage assembly 120.

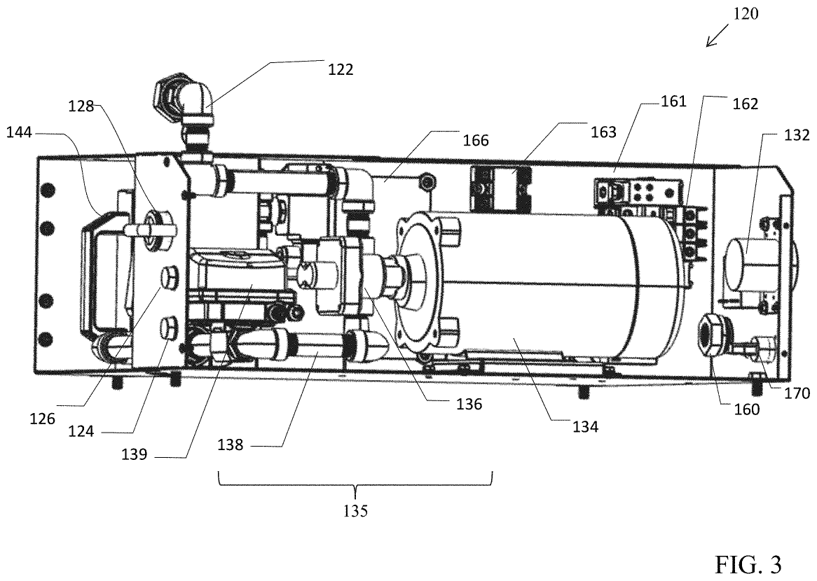

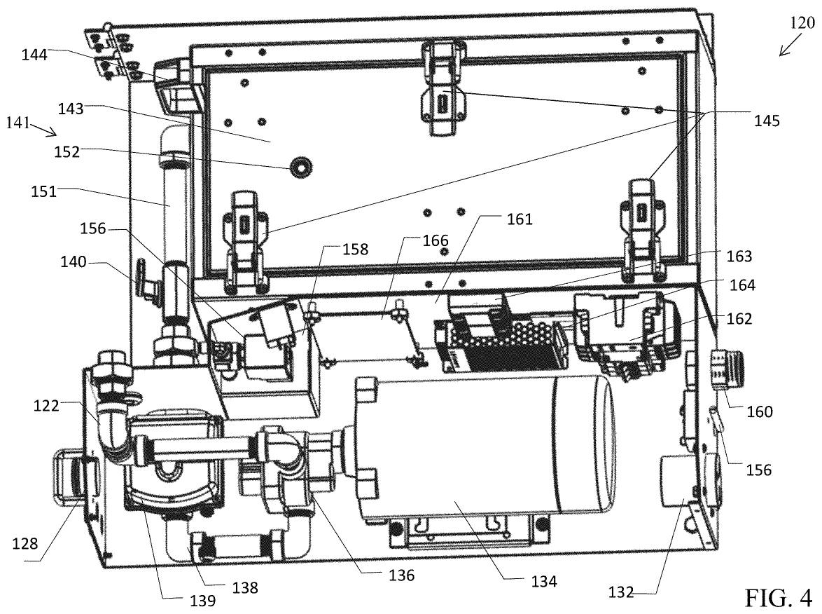

Referring now to FIGS. 3, 4, and 5, the interior components of the oil storage assembly 120 will be described. Beginning with FIGS. 3 and 4, the feed pipe 122 provides a conduit for the transfer of cooking oil between the fryer 102 and the oil storage assembly 120. A first end of the feed pipe 122 attaches to the previously described fryer fitting 114 and a second end of the feed pipe 122 attaches to a pump assembly 135. In the example illustrated in FIGS. 3 and 4, the pump assembly 135 comprises a motor 134, a pump 136, and a valve 139. The motor 134 drives the pump 136. The second end of the feed pipe 122 is attached to the pump 136 and the opposite side of the pump 136 is attached to a storage pipe 138. The valve 139 is attached to the storage pipe 138 and controls the flow of cooking oil. In the example oil storage assembly 120 illustrated in FIGS. 3 and 4, the valve 139 is operated by a solenoid, however, in alternate embodiments other types of valves may be implemented and the motor, the pump, and the valve can have alternate arrangements.

The oil storage assembly 120 also comprises components for supplying and controlling the electrical power that enables the fryer system 100 to operate. These electrical supply and control components are illustrated in FIGS. 3 and 4, but routine wiring connections have been omitted from the drawings for the sake of clarity in the drawings. A person of ordinary skill in this field would understand how to implement the routine wiring connections between the electrical supply and control components. Beginning with the supply of power, the fryer system 100 receives electrical power via a power cable connector 160. The power cable connector 160 can attach to a power source, such as one or more batteries, via a power cable. The batteries can be located onboard the vehicle and can be recharged by one or more of a variety of mechanisms, such as an alternator onboard the vehicle. The power cable connector 160 is electrically coupled within the oil storage assembly 120 to a circuit breaker 162 and a power supply 164. The power supply 164 can include a power converter, such as a transformer, that conditions power for use by the pump assembly 135 and the fryer 102.

Adjacent to the power supply 164 are a relay 163 and a controller 166. The controller 166 can control the supply of power via the relay 163 to the pump assembly 135 and to the fryer 102. When providing power to the pump assembly 135, the power can operate the motor 134 and the solenoid valve 139. When providing power to the fryer 102, the power supply 164 can provide power via power receptacle 132. In the example of fryer system 100, a power cable from the fryer 102 plugs into power receptacle 132 for providing power to the fryer 102. Controlling the supply of power to both the pump assembly 135 and the fryer 102 at the single controller 166 provides efficiency and safety advantages in that power to the two subsystems is controlled from one source. Additionally, in the example fryer system 100, the controller 166 and relay 163 are configured so that power cannot be simultaneously supplied to both the load of the pump assembly 135 and the load of the fryer 102. Limiting the delivery of power to one load at a time prevents the drawing of excessive power from the power supply, such as the onboard battery.

The controller 166 is shown in simplified fashion in FIGS. 3 and 4. As is known to those of skill in this field, the controller can comprise a printed circuit board that includes a processor, non-transitory computer-readable memory (which can include volatile and persistent memory), and a communication interface. One or more buses on the printed circuit board allows for communication among the components on the printed circuit board. The processor can be implemented in a variety forms that are generally known, including but not limited to a central processing unit, a multi-core processor, a system on a chip, a field programmable gate array, and an application-specific integrated circuit. The memory can store computer-readable instructions for execution by the processor as well as data such as operational data collected from the fryer system 100. In certain example embodiments, in addition to or as an alternative to local memory, computer-readable instructions and data can be stored remotely on a cloud-based server.

In addition to controlling the delivery of power via relay 163, the controller 166 provides the communication interface that can allow communication with the fryer system 100 via wired or wireless communication methods. For example, a USB port 170 in the oil storage assembly 120 can support wired communications with the controller 166. The USB port 170 can be used to update the computer-readable instructions stored in memory. Additionally, the USB port 170 can be used to collect data from the controller 166, such as when the vehicle returns to a command center or a food distribution location. Examples of the data collected from the controller 166 can include an identifier for the vehicle and/or the fryer system 100 and the number of oil fill and oil drain operations since the cooking oil was last replaced in the fryer.

With respect to example embodiments of the fryer system 100 that include wireless communication capability, the controller's communication interface can include a transceiver for transmitting and/or receiving wireless communications via antenna 156. The transceiver and antenna can be configured to communicate over one or more wireless networks including cellular networks such as 3G, 4G, and 5G, WiFi networks, and Bluetooth networks. As described further below in connection with FIGS. 6 and 7, the controller can send a variety of communications relating to the operation of the fryer system 100. For example, the controller can transmit signals via a cellular network to a remote command center identifying the vehicle or fryer system and indicating when an oil fill operation is complete or when an oil drain operation is complete. The controller can also transmit signals via short range networks such as WiFi and Bluetooth to local devices. For example, the controller can transmit a signal to a driver's display device within the vehicle when an oil drain operation is complete indicating that the vehicle can begin moving. As another example, if the transceiver and antenna of the fryer system 100 do not have cellular radio capability, the controller can transmit signals via a short range network to a local device such as smartphone or tablet having cellular radio capability and the smartphone or tablet can relay the signals to a remote command center.

As illustrated in FIGS. 3, 4, and 5, a divider 161 is positioned along the majority of the depth of the oil storage assembly 120 and bisects the oil storage assembly 120 into two subassemblies. The previously described electrical components are located on one side of the divider 161 and the storage subassembly 141 that stores the cooking oil is located on the opposite side of the divider 161. As previously described, a storage pipe 138 is in fluid communication with the pump 136 and includes the valve 139 along its length. Specifically, a first end of the storage pipe 138 is attached to the pump 136 and a second end of the storage pipe 138 extends towards the storage subassembly 141 and attaches to a storage tank fitting 151. The second end of the storage pipe 138 and the storage tank fitting 151 can be joined by known methods such as union 150.

The storage subassembly 141 includes a storage tank 147 from which the storage tank fitting 151 extends. After cooking has been heated and used for cooking in the fry pot 113, an oil drain operation drains the heated cooking oil from the fry pot 113 and into the storage tank 147. The storage tank 147 securely stores the heated cooking oil while the vehicle is in motion. The storage tank 147 is secured within a storage box 142 within the storage subassembly 141. In example embodiments, the interior walls of the storage box 142 can be lined with insulation to minimize the dissipation of heat from the cooking oil that has been drained from the fry pot 113 and stored in the storage tank 147. Minimizing heat dissipation from the cooking oil improves efficiency both with respect to energy and time in that when the vehicle arrives at the next destination for preparing food, the heated cooking oil will be pumped from the storage tank 147 and back into the fry pot 113 and will require less heating energy and time before the cooking oil reaches the required temperature for resuming cooking.

The cooking oil used in the fryer system 100 will need to be periodically replaced for filtering and reuse or disposal. Accordingly, the configuration of the storage tank 147 and the storage box 142 shown in FIGS. 3, 4, and 5 facilitates insertion and removal of the storage tank 147 from the storage subassembly 141. When inserting a storage tank 147 containing cooking oil into the storage subassembly 141, the operator grasps storage box handle 144 and pulls the storage box 142 out of the storage subassembly 141. Latches 145 located at the top of the storage box 142 are released and the storage box door 143 is removed from the top of the storage box 142. The storage tank 147 containing the cooking oil is placed inside the empty storage box 142. The storage box 142 includes a storage box slot 146 so that the storage tank fitting 151 that extends from the storage tank 147 can fit through the storage box slot 146. As illustrated in FIGS. 3, 4, and 5, the storage tank fitting 151 extends from the front face of the storage tank 147, passes through the storage box slot 146, and then bends at a 90 degree angle towards the union 150 and the storage pipe 138.

Once the storage tank 147 is secured inside the storage box 142, the storage box door 143 is attached to the storage box 142 with latches 145 and the operator pushes the storage box 142 into the storage subassembly 141. The storage tank fitting 151 is attached to the storage pipe 138 with union 150. Next, the operator can turn the storage tank valve 140 in the storage tank fitting 151 from the closed position to the open position so that the cooking oil can flow from the storage tank 147, through the storage tank fitting 151 through the storage tank valve 140, and through the storage pipe 138 towards the pump assembly 135.

The storage tank 147 includes an air valve (not shown) that is aligned with the air vent 152 in the storage box door 143 of the storage box 142. The air valve allows air to exit and enter the storage tank 147 in order to facilitate the pumping of cooking oil into and out of the storage tank 147 during the oil drain and oil fill operations. Optionally, the air vent 152 can be connected by a tube (not shown) to an oil catch aperture 154 located in the divider 161. During an oil drain operation when cooking oil is pumped into the storage tank 147, air is released from the storage tank 147 through the air valve in the storage tank 147 and the air vent 152 in the storage box door 143. As air is released, some of the cooking oil may also escape through the air valve and the air vent. The cooking oil that escapes the storage tank 147 travels along the tube to the oil catch aperture 154. The oil catch aperture is attached to an oil catch valve 156 that diverts the escaping cooking oil into an oil catch container 158 while the escaping air is released in into the ambient environment. The cooking oil captured in the oil catch container 158 can be disposed of periodically. In alternate embodiments, the fryer system 100 may not include the oil catch aperture 154, oil catch valve 156, and oil catch container 158.

Lastly, the operator closes the oil storage access door 129. Before beginning an oil fill operation, the operator can check the components of the fryer 102. The operator can open the fryer access door 104 to ensure that the fryer fitting is attached to the feed pipe 122. Additionally, the operator can confirm that the fryer valve 115 is in the open position.

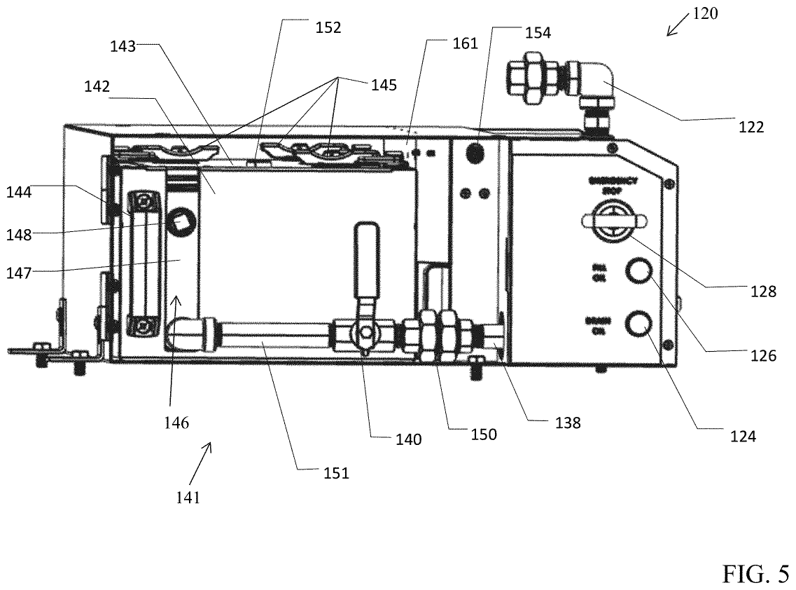

When removing the storage tank 147 from the storage assembly 141, the operator opens the oil storage access door 129 and rotates the storage tank valve 140 to the closed position. Next, the operator can decouple the storage pipe 138 from the storage tank fitting 151 at the union 150. The operator can grasp the storage box handle 144 and pull the storage box 142 from the storage assembly 141. The operator can replace the entire storage box 142 and storage tank 147 with a new storage box and storage tank. Alternatively, the operator can remove the storage tank 147 from the storage box 142 and place a new storage tank in the storage box 142. Also shown in FIG. 5 is a drain port 148 on the front face of the storage tank 147. The cooking oil is removed via the drain port 148 from the storage tank 147 at a site that either filters or disposes of the cooking oil.

Referring now to FIGS. 6 and 7, example methods for operation of the fryer system 100 are illustrated. The example methods illustrated in FIGS. 6 and 7 can include algorithms stored as computer-readable instructions in the memory of the controller 166 for execution by the processor. FIG. 6 illustrates an example method 600 that includes an oil fill operation, whereas FIG. 7 illustrates an example method 700 that includes an oil drain operation.

Referring to FIG. 6, example method 600 begins with the vehicle arriving at a customer location, such as a home or business, where the operator can begin preparing food. In step 610, the operator confirms that the fryer system 100 is ready for operation by confirming that the fryer valve 115 and the storage tank valve 140 are in the open position. The operator can skip step 610 if the operator already knows that these valves are open. In step 615, the operator engages the oil fill button 126 causing the controller 166 to supply power to the pump assembly 135 which causes the motor 134 to start and causes the solenoid valve 139 to open. In step 620, the pump 136 drives cooking oil from the storage tank 147, through storage pipe 138, through feed pipe 122, through fryer fitting 114, and into the fry pot 113. One advantage of the fryer system 100 is that it can rapidly transfer the cooking oil from the storage tank 147 to the fry pot 113 so that the operator can promptly begin cooking. As one example, the pump assembly 135 can pump cooking oil from the storage tank 147 to the fry pot 113 within 30 seconds.

After the pump 136 has driven the cooking oil into the fry pot 113, the controller 166 turns off power to the pump assembly 135 causing the motor 134 to turn off and causing the solenoid valve 139 to close in step 625. As one example, the controller may turn off power to the pump assembly 135 after a predetermined time required to pump the cooking oil into the fry pot 113, such as thirty seconds. With the power to the pump assembly 135 turned off, the controller 166 begins supplying power to the fryer 102. The operator can set the fryer 102 to a desired temperature, such as at or about 175 degrees F., and the fryer 102 includes a temperature controller that turns on the heating element as needed to raise the temperature of the cooking oil to the desired temperature. If the cooking oil was recently heated in a previous cooking operation, the insulated storage tank 147 will have assisted in minimizing heat losses while the cooking oil was stored. Accordingly, in contrast with prior art approaches, bringing the cooking oil to the desired temperature will be quicker and more efficient when the heat losses have been minimized with the example fryer system 100. In step 630, the controller 166 sends a signal to a remote command center via the antenna 156 indicating that the oil fill operation is complete. As explained previously, the controller 166 and antenna 156 may send the signal via a cellular radio network or may send the signal via a short range network to a local computing device which can then relay the signal via a cellular radio network. In step 635, the operator can begin the cooking operation with the fryer 102.

Referring now to FIG. 7, an example method 700 begins with the operator completing a cooking operation with the fryer 102 in step 705. The operator will now perform an oil drain operation so that the vehicle can proceed to another location with the heated cooking oil securely stored so that it will not spill. In step 710, the operator engages the oil drain button 124 causing the controller 166 to turn off power to the fryer 102 and to turn on power to the pump assembly 135. Supplying power to the pump assembly 135 causes the motor 134 for the pump 136 to turn on and causes the solenoid valve 139 to open. In step 715, the pump 136 drives the cooking oil from the fry pot 113, through the fryer fitting 114, through the feed pipe 122, through the storage pipe 138, through the storage tank fitting 151, and into the storage tank 147. In step 720, when the pump 136 has pumped the cooking oil from the fry pot 113 into the storage tank 147, the controller turns off power to the pump assembly 135 causing the motor 134 to turn off and the solenoid valve 139 to close. As one example, the controller may turn off power to the pump assembly after a predetermined period of time required to pump the cooking oil from the fry pot 113 into the storage tank 147, such as thirty seconds. Optionally, in step 725, the operator can close the storage tank valve 140. Alternatively, the operator may leave the storage tank valve 140 open and rely on the closed solenoid valve 139 to keep the cooking oil in the oil storage assembly 120.

In step 730, the controller 166 sends a signal to the remote command center indicating that the oil drain operation is complete. As explained previously, the signal may be sent directly by the transceiver of the controller 166 and the antenna 156 via a cellular network or the signal may sent to a local computing device for relaying to the remote command center. The remote command center may use the signal to track the status of the vehicle and/or to send new instructions to the vehicle to proceed to another customer location. Optionally, the local computing device can use the signal from the controller as an indication to the driver that the vehicle can begin moving. Lastly, in step 735, the vehicle can begin moving now that the cooking oil is secured in the storage tank 147.

With respect to the example methods described herein, it should be understood that in alternate embodiments, certain steps of the methods may be performed in a different order, may be performed in parallel, or may be omitted. Moreover, in alternate embodiments additional steps may be added to the example methods described herein. Accordingly, the example methods provided herein should be viewed as illustrative and not limiting of the disclosure.

Similarly, for any apparatus shown and described herein, one or more of the components may be omitted, added, repeated, and/or substituted. Accordingly, embodiments shown in a particular figure should not be considered limited to the specific arrangements of components shown in such figure. Further, if a component of a figure is described but not expressly shown or labeled in that figure, the label used for a corresponding component in another figure can be inferred to that component. Conversely, if a component in a figure is labeled but not described, the description for such component can be substantially the same as the description for the corresponding component in another figure.

Referring generally to the examples herein, any components of the apparatus (e.g., the storage tank and storage box, the pipes and fittings, the valves and pump), described herein can be made from a single piece (e.g., as from a mold, injection mold, die cast, 3-D printing process, extrusion process, stamping process, or other prototype methods). In addition, or in the alternative, a component of the apparatus can be made from multiple pieces that are mechanically coupled to each other. In such a case, the multiple pieces can be mechanically coupled to each other using one or more of a number of coupling methods, including but not limited to epoxy, welding, fastening devices, compression fittings, mating threads, and slotted fittings. One or more pieces that are mechanically coupled to each other can be coupled to each other in one or more of a number of ways, including but not limited to couplings that are fixed, hinged, removeable, slidable, and threaded.

Terms such as “first”, “second”, “top”, “bottom”, “side”, “distal”, “proximal”, and “within” are used merely to distinguish one component (or part of a component or state of a component) from another. Such terms are not meant to denote a preference or a particular orientation, and are not meant to limit the embodiments described herein. In the example embodiments described herein, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Although example embodiments are described herein, it should be appreciated by those skilled in the art that various modifications are well within the scope of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

What is claimed is:

1. A fryer system comprising:
a fryer, the fryer comprising a fry pot for containing cooking oil during a cooking process; and
an oil storage assembly, the oil storage assembly comprising:
a feed pipe coupled at a first end to the fry pot via a fryer fitting and coupled at a second end to a pump assembly, wherein the pump assembly comprises a pump and a valve, and
a storage pipe coupled at a first end to the pump assembly and coupled at a second end to a storage tank via a storage tank fitting, the storage tank fitting comprising a storage valve.

2. The apparatus of claim 1, wherein the fryer is disposed on top of the oil storage assembly.

3. The apparatus of claim 1, wherein the oil storage assembly further comprises:
a controller that controls operation of the pump and the valve.

4. The apparatus of claim 3, wherein the controller controls, via a relay, delivery of power to the pump and to the fryer.

5. The apparatus of claim 4, wherein the oil storage assembly further comprises an electrical receptacle for receiving a fryer power cord and coupling the fryer power cord to the relay.

6. The apparatus of claim 3, wherein the controller transmits, via an antenna, to a remote command center:
an oil fill signal when the pump drives cooking oil from the storage tank to the fry pot, and
an oil drain signal when the pump drives cooking oil from the fry pot to the storage tank.

7. The apparatus of claim 3, wherein the controller transmits, via an antenna, to a driver display device a ready message when the pump drives cooking oil from the fry pot to the storage tank.

8. The apparatus of claim 3, wherein the controller senses when the pump has completed pumping the cooking oil.

9. The apparatus of claim 3, wherein the oil storage assembly further comprises a universal serial bus port coupled to the controller.

10. The apparatus of claim 1, wherein the oil storage assembly further comprises:
an oil catch valve, wherein the oil catch valve is coupled, via a tube, to an air valve in the storage tank, and
wherein the oil catch valve directs oil that exits the air valve into an oil catch container.

11. The apparatus of claim 1, wherein the storage tank is enclosed within a storage box that is removable from the oil storage assembly.

12. The apparatus of claim 11, wherein the storage box comprises a slot to accommodate the storage tank fitting.

13. A method for operating a fryer system, the method comprising:
an oil fill operation, wherein the oil fill operation comprises:
supplying power, by a controller, to a pump assembly comprising a pump and a valve;
driving, by the pump, cooking oil from a storage tank, through a storage pipe, through a feed pipe, and into a fry pot of a fryer; and
transmitting, by the controller, an oil fill completion signal to a remote command center;
a cooking operation comprising cooking food by the fryer; and
an oil drain operation, wherein the oil drain operation comprises:
supplying power, by the controller, to the pump and the valve of the pump assembly;
driving, by the pump, cooking oil from the fry pot, through the feed pipe, through the storage pipe, and into the storage tank; and
transmitting, by the controller, an oil drain completion signal to the remote command center.

14. The method of claim 13, wherein the controller withholds power from the fryer when the controller supplies power to the pump assembly during the oil fill operation.

15. The method of claim 13, further comprising:
withholding power, by the controller, from the pump assembly after the oil fill operation is complete; and
supplying power, by the controller, to the fryer during the cooking operation.

16. The method of claim 13, wherein the controller withholds power from the fryer when the controller supplies power to the pump assembly during the oil drain operation.

17. The method of claim 13, further comprising:
transmitting, by the controller, a ready message to a driver display device a ready message when the oil drain operation is complete.

18. The method of claim 13, further comprising:
opening a storage tank valve and a fryer valve before the oil fill operation.

19. The method of claim 13, further comprising:
closing a storage tank valve and a fryer valve after the oil drain operation.

20. The method of claim 13, further comprising:
removing the storage tank from the fryer system after the oil drain operation.
